(19) United States
(12) Patent Application Publication
(10) Pub. No.: US 2005/0260984 A1
(43) Pub. Date: Nov. 24, 2005

(54) Systems and methods for space-based use of terrestrial cellular frequency spectrum

(75) Inventor: Peter D. Karabinis, Cary, NC (US)

Correspondence Address: MYERS BIGEL SIBLEY & SAJOVEC, PO BOX 37428, RALEIGH, NC, 27627, US

(73) Assignee: Mobile Satellite Ventures, LP

(21) Appl. No.: 11/131,044

(22) Filed: May 17, 2005

Related U.S. Application Data
(60) Provisional application No. 60/573,253, filed on May 21, 2004.

(51) Int. Cl. H04B 7/185

(52) U.S. Cl. 455/428; 455/422.1; 455/12.1

(57) ABSTRACT

A space-based component, such as a satellite, is configured to use a terrestrial cellular/PCS frequency for communication with a wireless terminal, with a terrestrial base station and/or with a terrestrial gateway. Terrestrial cellular/PCS frequencies also may be used for terrestrial communications by terrestrial base stations and/or radioterminals.

### CROSS-REFERENCE TO RELATED APPLICATION

This application claims the benefit of provisional Application No. 60/573,253, filed May 21, 2004, entitled Systems and Methodsfor Space-Based Reuse of Terrestrial Cellular Frequency Spectrum, the disclosure of which is hereby incorporated herein by reference in its entirety as if set forth fully herein.

### FIELD OF THE INVENTION

This invention relates to radioterminal communications systems and methods, and more particularly to terrestrial cellular and satellite cellular radioterminal communications systems and methods.

### BACKGROUND OF THE INVENTION

Satellite radioterminal communications systems and methods are widely used for radioterminal communications. Satellite radioterminal communications systems and methods generally employ at least one space-based component, such as one or more satellites, that is/are configured to wirelessly communicate with a plurality of satellite radioterminals.

A satellite radioterminal communications system or method may utilize a single antenna pattern (beam) covering an entire area served by the system. Alternatively, in cellular satellite radioterminal communications systems and methods, multiple antenna patterns (beams or cells) are provided, each of which can serve substantially distinct geographical areas in the overall service region, to collectively serve an overall satellite footprint. Thus, a cellular architecture similar to that used in conventional terrestrial cellular radioterminal systems and methods can be implemented in cellular satellite-based systems and methods. The satellite typically communicates with radioterminals over a bidirectional communications pathway, with radioterminal communication signals being communicated from the satellite to the radioterminal over a downlink or forward link, and from the radioterminal to the satellite over an uplink or return link.

The overall design and operation of cellular satellite radioterminal systems and methods are well known to those having skill in the art, and need not be described further herein. Moreover, as used herein, the term “radioterminal” includes cellular and/or satellite radioterminals with or without a multi-line display; Personal Communications System (PCS) terminals that may combine a radioterminal with data processing, facsimile and/or data communications capabilities; Personal Digital Assistants (PDA) that can include a radio frequency transceiver and/or a pager, Internet/Intranet access, Web browser, organizer, calendar and/or a global positioning system (GPS) receiver; and/or conventional laptop and/or palmtop computers or other appliances, which include a radio frequency transceiver. A radioterminal also may be referred to herein as a “radiotelephone”, “wireless terminal” or simply as a “terminal”. As used herein, the term(s) “radiotelephone”, “radioterminal”, “wireless terminal” and/or “terminal” also include(s) any other radiating user device/equipment/source that may have time-varying or fixed geographic coordinates and/or may be portable, transportable, installed in a vehicle (aeronautical, maritime, or land-based) and/or situated and/or configured to operate locally and/or in a distributed fashion over one or more terrestrial and/or extra-terrestrial location(s).

Terrestrial networks can enhance cellular satellite radioterminal system availability, efficiency and/or economic viability by terrestrially using and/or reusing at least some of the frequency bands that are allocated to cellular satellite radioterminal systems. In particular, it is known that it may be difficult for cellular satellite radioterminal systems to reliably serve densely populated areas, because the satellite signal may be blocked by high-rise structures and/or may not penetrate into buildings. As a result, the satellite spectrum may be underutilized or unutilized in such areas. The terrestrial use and/or reuse of the satellite system frequencies can reduce or eliminate this potential problem.

Moreover, the capacity of the overall system may be increased by the introduction of terrestrial frequency use and/or reuse of the satellite system frequencies, since terrestrial frequency use and/or reuse may be much denser than that of a satellite-only system. In fact, capacity may be enhanced where it may be mostly needed, i.e., in densely populated urban/industrial/commercial areas. As a result, the overall system may become more economically viable, as it may be able to serve more effectively and reliably a larger subscriber base.

One example of terrestrial use of satellite frequencies is described in U.S. Pat. No. 5,937,332 to the present inventor Karabinis entitled Satellite Telecommunications Repeaters and Retransmission Methods, the disclosure of which is hereby incorporated herein by reference in its entirety as if set forth fully herein. As described therein, satellite telecommunications repeaters are provided which receive, amplify, and locally retransmit the downlink signal received from a satellite thereby increasing the effective downlink margin in the vicinity of the satellite telecommunications repeaters and allowing an increase in the penetration of uplink and downlink signals into buildings, foliage, transportation vehicles, and other objects which can reduce link margin. Both portable and non-portable repeaters are provided. See the abstract of U.S. Pat. No. 5,937,332.

Satellite radioterminals for a satellite radioterminal system or method having a terrestrial communications capability by terrestrially using and/or reusing at least some of the same satellite frequency band and using substantially the same air interface for both terrestrial and satellite communications may be cost effective and/or aesthetically appealing. Conventional dual band/dual mode radioterminal alternatives, such as the well known Thuraya, Iridium and/or Globalstar dual mode satellite/terrestrial radioterminals, duplicate some components (as a result of the different frequency bands and/or air interface protocols between satellite and terrestrial communications), which leads to increased cost, size and/or weight of the radioterminal. See U.S. Pat. No. 6,052,560 to the present inventor Karabinis, entitled Satellite System Utilizing a Plurality of Air Interface Standards and Method Employing Same.

Satellite radioterminal communications systems and methods that may employ terrestrial use of satellite frequencies are described in U.S. Pat. Nos. 6,684,057 to Karabinis, entitled Systems and Methods for Terrestrial Reuse of Cellular Satellite Frequency Spectrum; 6,785,543 to Karabinis, entitled Filters for Combined Radiotelephone/GPS Terminals; 6,856,787 to Karabinis, entitled Wireless Communications Systems and Methods Using Satellite-Linked Remote Terminal Interface Subsystems; 6,859,652 to Karabinis et al., entitled Integrated or Autonomous System and Method of Satellite-Terrestrial Frequency Reuse Using Signal Attenuation and/or Blockage, Dynamic Assignment of Frequencies and/or Hysteresis; and 6,879,829 to Dutta et al., entitled Systems and Methods for Handover Between Space Based and Terrestrial Radioterminal Communications, and For Monitoring Terrestrially Reused Satellite Frequencies At a Radioterminal to Reduce Potential Interference; and Published U.S. patent application Ser. Nos. US 2003/0054761 to Karabinis, entitled Spatial Guardbands for Terrestrial Reuse of Satellite Frequencies; US 2003/0054814 to Karabinis et al., entitled Systems and Methods for Monitoring Terrestrially Reused Satellite Frequencies to Reduce Potential Interference; US 2003/0073436 to Karabinis et al., entitled Additional Systems and Methods for Monitoring Terrestrially Reused Satellite Frequencies to Reduce Potential Interference; US 2003/0054762 to Karabinis, entitled Multi-Band/Multi-Mode Satellite Radiotelephone Communications Systems and Methods; US 2003/0224785 to Karabinis, entitled Systems and Methods for Reducing Satellite Feeder Link Bandwidth/Carriers In Cellular Satellite Systems; US 2002/0041575 to Karabinis et al., entitled Coordinated Satellite-Terrestrial Frequency Reuse; US 2003/0068978 to Karabinis et al., entitled Space-Based Network Architectures for Satellite Radiotelephone Systems; US 2003/0153308 to Karabinis, entitled Staggered Sectorization for Terrestrial Reuse of Satellite Frequencies; and US 2003/0054815 to Karabinis, entitled Methods and Systems for Modifying Satellite Antenna Cell Patterns In Response to Terrestrial Reuse of Satellite Frequencies, all of which are assigned to the assignee of the present invention, the disclosures of all of which are hereby incorporated herein by reference in their entirety as if set forth fully herein.

Some satellite radioterminal communications systems and methods may employ satellites that use multiple bands for communications with radioterminals. For example, U.S. patent application Publication No. US 2003/0054762 to Karabinis, cited above, describes satellite radioterminal systems and communications methods that include a space-based component that is configured to communicate with radioterminals in a satellite footprint that is divided into satellite cells. The space-based component is configured to communicate with a first radioterminal in a first satellite cell over a first frequency band and/or a first air interface, and to communicate with a second radioterminal in the first or a second satellite cell over a second frequency band and/or a second air interface. An ancillary terrestrial network also is provided that is configured to communicate terrestrially with the first radioterminal over substantially the first frequency band and/or substantially the first air interface, and to communicate terrestrially with the second radioterminal over substantially the second frequency band and/or substantially the second air interface. See the Abstract of U.S. patent application Publication No. US 2003/0054762.

### SUMMARY OF THE INVENTION

Wireless communication methods according to exemplary embodiments of the present invention directly communicate between a space-based component and a radioterminal over a terrestrial cellular/PCS frequency. In other embodiments, direct communication between a terrestrial base station and the radioterminal also may be provided over a terrestrial cellular/PCS frequency. In still other embodiments, direct communication between a terrestrial base station and the space-based component may be provided over a terrestrial cellular/PCS frequency. Combinations and subcombinations of these embodiments also may be provided.

Other embodiments of the present invention allow a space-based component to use a terrestrial cellular/PCS frequency. In other embodiments, a terrestrial cellular/PCS frequency is used by a radioterminal to directly communicate with a space-based component. In still other embodiments, a terrestrial cellular/PCS frequency is used by a terrestrial base station to directly communicate with a space-based component. Combinations and subcombinations of these embodiments also may be provided.

Wireless communications systems according to exemplary embodiments of the present invention include a space-based component that is configured to directly communicate with a radioterminal over a terrestrial cellular/PCS frequency. In other embodiments, a terrestrial base station also is provided that is configured to directly communicate with the radioterminal over a terrestrial cellular/PCT frequency. In other embodiments, a terrestrial base station is configured to directly communicate with a space-based component over a terrestrial cellular/PCS frequency. Combinations and subcombinations of these embodiments also may be provided.

Finally, in other exemplary embodiments of wireless communications systems, a space-based component is configured to use a terrestrial cellular/PCS frequency. In other embodiments, a radioterminal is configured to directly communicate with a space-based component over a terrestrial cellular/PCS frequency. In still other embodiments, the radioterminal is further configured to directly communicate with a terrestrial base station over a terrestrial cellular/PCS frequency. In still other embodiments, a terrestrial base station is configured to directly communicate with a space-based component over a terrestrial cellular/PCS frequency. Combinations and subcombinations of these embodiments also may be provided.

### BRIEF DESCRIPTION OF THE DRAWINGS

FIGS. 1-3 are block diagrams of systems, methods and/or components for space-based use of terrestrial cellular frequency spectrum according to various embodiments of the present invention.

### DETAILED DESCRIPTION

Specific exemplary embodiments of the invention now will be described with reference to the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, like designations refer to like elements. It will be understood that when an element is referred to as being “connected”, “coupled” or “responsive” to another element, it can be directly connected, coupled or responsive to the other element or intervening elements may be present. Furthermore, “connected”, “coupled” or “responsive” as used herein may include wirelessly connected, coupled or responsive.

The terminology used herein is for the purpose of describing particular embodiments only and is not intended to be limiting of the invention. As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

It will be understood that although the terms first and second may be used herein to describe various elements, these elements should not be limited by these terms. These terms are only used to distinguish one element from another element. Thus, a first radioterminal below could be termed a second radioterminal, and similarly, a second radioterminal may be termed a first radioterminal without departing from the teachings of the present invention. As used herein, the term “and/or” includes any and all combinations of one or more of the associated listed items. The symbol “/” is also used as a shorthand notation for “and/or”.

Moreover, as used herein, “substantially the same” band(s) means that two or more bands being compared substantially overlap in frequency, but that there may be some areas of non-overlap, for example at a band end(s). “Substantially the same” air interface(s) means that two or more air interfaces being compared are similar but need not be identical. Some differences may exist in one air interface (i.e., a satellite air interface) relative to another (i.e., a terrestrial air interface) to account for and/or accommodate different characteristics that may exist between, for example, a terrestrial and satellite communications environments. For example, a different vocoder rate may be used for satellite communications compared to the vocoder rate that may be used for terrestrial communications (i.e., for terrestrial communications, voice may be compressed (“vocoded”) to approximately 9 to 13 kbps, whereas for satellite communications a vocoder rate of 2 to 4 kbps, for example, may be used); a different forward error correction coding, different interleaving depth, and/or different spread-spectrum codes may also be used, for example, for satellite communications compared to the coding, interleaving depth, and/or spread spectrum codes (i.e., Walsh codes, long codes, and/or frequency hopping codes) that may be used for terrestrial communications.

Some embodiments of the present invention allow terrestrial cellular/PCS frequencies to be used for space-based communications. As used herein, terrestrial cellular frequencies are in the range of 824-849 MHz and 869-894 MHz in the United States, and terrestrial PCS frequencies are in the range of 1850-1910 MHz and 1930-1990 MHz in the United States. Terrestrial cellular frequencies may be in the range of 890-915 MHz and 930-960 MHz for GSM systems, and other countries may have their own ranges of terrestrial cellular/PCS frequencies.

A terrestrial cellular/PCS frequency and/or any other frequency that is authorized and/or used for terrestrial communications in conjunction with any system (cellular/PCS and/or other), collectively referred to hereinafter as “cellular/PCS frequency”, may be used by a space-based component, a terrestrial base station and/or a radioterminal for space-based communications in one or more of many modes according to various embodiments of the present invention. For example, use of a given terrestrial cellular/PCS frequency for space-based communications may be exclusive or shared. In particular, in some embodiments, a terrestrial cellular/PCS frequency (or a band of frequencies) may be assigned to a space-based component or a terrestrial base station in an exclusive manner, such that the frequency (or band of frequencies) is only used by the space-based component or the terrestrial base station. Such an assignment results in “band segmentation” of at least a portion of a terrestrial cellular/PCS frequency band. In other embodiments, a terrestrial cellular/PCS frequency is reused by the space-based component and/or a terrestrial cellular/PCS system, so that the same frequency may be used simultaneously for space-based and terrestrial communications. Interference reduction and/or other techniques may be used to reduce interference due to reuse. The exclusive assignment and/or shared reuse of a given terrestrial cellular/PCS frequency (or band of frequencies) may be performed on a temporary and/or permanent basis. Thus, as used herein, the term “use”, as applied to a terrestrial cellular/PCS frequency (or band of frequencies that may be contiguous or non-contiguous), contemplates band segmentation and/or reuse of a permanent and/or dynamic nature. It will also be understood that, as used herein, the term “terrestrial” means “not in space” and can include land-based, maritime and/or aeronautical devices/systems.

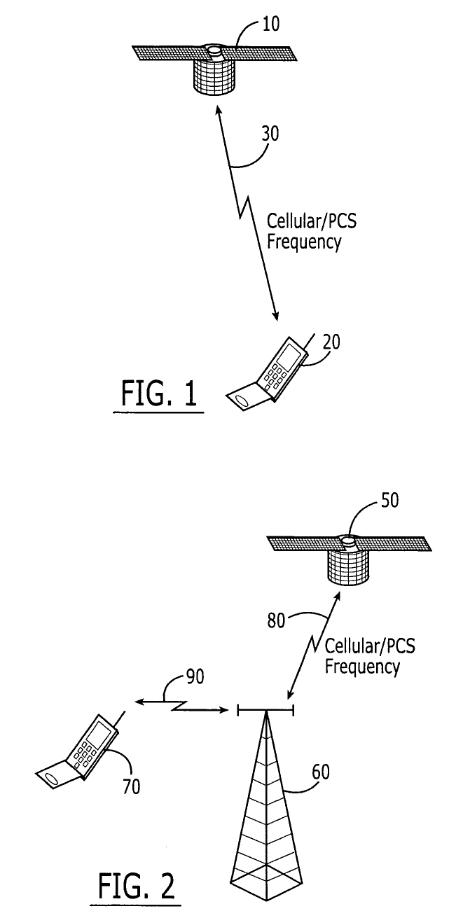

FIG. 1 illustrates exemplary embodiments of the present invention. As shown in FIG. 1, a space-based component, such as a satellite 10 directly communicates with a radioterminal 20 over a link 30 that includes a terrestrial cellular/PCS frequency. It will be understood by those having skill in the art that, in other embodiments of FIG. 1, a space-based component, such as a satellite 10, may use a terrestrial cellular/PCS frequency for other purposes, for example to communicate with a gateway.

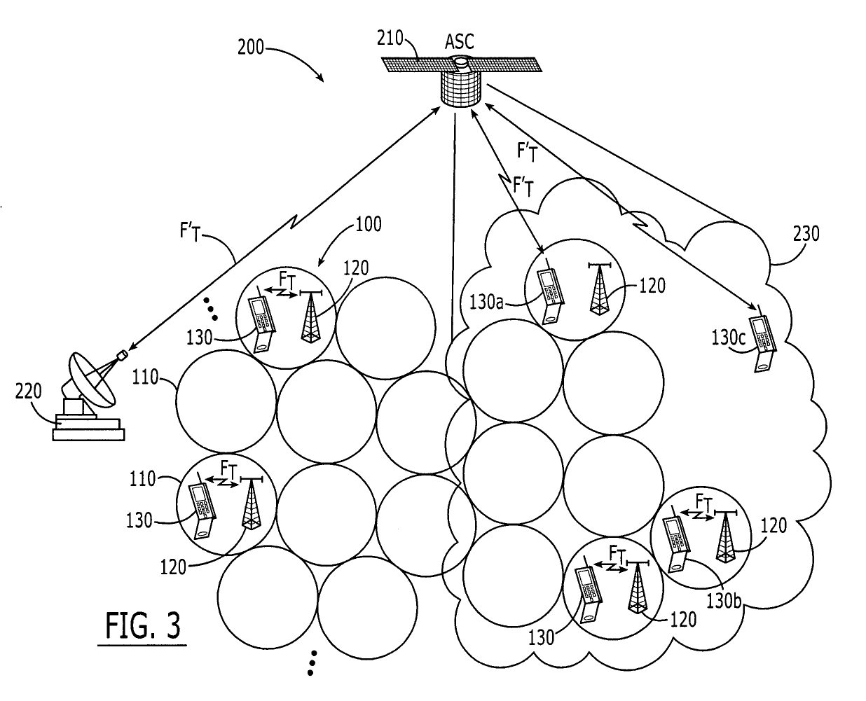

FIG. 2 illustrates other embodiments of the present invention, wherein a space-based component, such as a satellite 50, directly communicates with a terrestrial base station 60 over a link 80 that includes a cellular/PCS frequency. Communications may also take place directly between the terrestrial base station 60 and a radioterminal 70 over a link 90 that includes a terrestrial cellular/PCS and/or satellite frequency. In embodiments of FIG. 2, when the link 90 between the radioterminal 70 and the terrestrial base station 60 includes a cellular/PCS frequency, a given cellular/PCS frequency may be assigned to the link 80 between the satellite 50 and the terrestrial base station 60 exclusively and/or a given cellular/PCS frequency may be reused by both the link 80 between the space-based component 50 and the terrestrial base station 60 and by the link 90 between the radioterminal 70 and the terrestrial base station 60. A specific embodiment employing reuse will be described in connection with FIG. 3 below. It will be understood that the terrestrial base station 60 may be permanently fixed at a particular geographic location, transportable or installed on a moving vehicle, such as, for example, on a maritime, aeronautical or land-mobile vehicle.

Some embodiments of the present invention allow terrestrial cellular frequencies to be used by an Ancillary Space Network (ASN) that includes one or more Ancillary Space Components (ASC), such as satellites. As used in the description of FIG. 3, terrestrial cellular frequencies include PCS frequencies and/or any other frequencies that are authorized and/or used for terrestrial communications. The ASN that uses terrestrial cellular frequencies can enhance terrestrial cellular radioterminal system availability, efficiency and/or economic viability by using at least some of the frequency bands that are allocated to terrestrial cellular radioterminal systems for space-based communications. In particular, it is known that it may be difficult for terrestrial cellular radioterminal systems to reliably serve sparsely populated areas, because of the potentially large infrastructure costs that may be associated therewith. Accordingly, true nationwide and/or regional coverage of a terrestrial cellular system may be difficult to attain. Space-based use of the terrestrial cellular system frequencies can reduce or eliminate this potential problem.

Moreover, the capacity of the overall system may be increased by the introduction of space-based frequency use of the terrestrial system frequencies particularly in areas where the deployment of terrestrial infrastructure may be prohibitive economically. As a result, the terrestrial cellular system may become more economically viable, and/or more attractive to subscribers as it may be able to serve more effectively and reliably a larger subscriber base.

The techniques that are described in the above-cited patents and published patent applications that are assigned to the assignee of the present invention may be used in a combined terrestrial/satellite system that uses terrestrial cellular frequencies in space (for space-based communications). Accordingly, systems, methods and/or components that are described in the above-cited patents and/or patent applications may be modified by using cellular frequencies rather than satellite frequencies throughout. Moreover, systems, methods and/or components that are described in other existing or future patents, patent applications, technical publications or other disclosures may be modified to use cellular frequencies in space. It will be understood that, according to embodiments of the present invention, an entire ASN or components thereof, such as, for example, filters, amplifiers, antennas, mixers, etc. may be appropriately modified in frequency response/characteristics to operate with terrestrial cellular/PCS frequencies to thereby allow space-based communications with terrestrial cellular/PCS frequencies. It will also be understood that elements/features/components/parameters of a radioterminal that is configured to communicate with a space-based component using frequencies of a satellite band may also be used substantially as elements/features/components/parameters of a radioterminal that is configured to communicate with a space-based component using frequencies of a cellular/PCS band. For example, a vocoder may be a lower-rate vocoder (i.e., a 2.4 kbps vocoder), an antenna element may be a higher-gain and/or a circularly-polarized antenna element and/or a maximum power limit of a power amplifier may be higher (i.e., 3 dB higher) compared to respective elements/features/components/parameters that the radioterminal may use to communicate terrestrially.

Accordingly, a cellular/PCS wireless network, whether existing or not, such as those that are currently marketed by Verizon, Cingular, Nextel, etc., that is using a band of cellular/PCS frequencies, may deploy an ASN including at least one satellite, and configure such ASN to provide service using at least one frequency of the cellular/PCS network. Users of the cellular/PCS network may thereby obtain true nationwide/regional/global coverage via satellite.

FIG. 3 is a block diagram of systems and methods for space-based reuse of terrestrial cellular frequency spectrum according to various embodiments of the present invention. As shown in FIG. 3, a conventional cellular network 100 employs a plurality of cells 110, each of which employs one or more base stations 120 for communications with one or more radioterminals 130 using one or more terrestrial cellular frequencies F_{T}. It will be understood by those having skill in the art that larger numbers of cells 110, base stations 120 and radioterminals 130 generally are employed in a cellular network 100, than are illustrated in FIG. 3. Moreover, an infrastructure of the cellular network 100 is not shown for clarity. The design of a terrestrial cellular network 100 is well known to those having skill in the art and need not be described further herein.

As also shown in FIG. 3, an ASN 200 employing at least one ASC 210 and at least one gateway 220 that use at least one terrestrial cellular frequency F′_{T}, may be used to communicate with at least some of the radiotenninals 130. In some embodiments, substantially the same or a portion of the terrestrial frequency band is used and, in other embodiments, the same terrestrial frequency band is used for space-based communications by the ASN 200. Thus, the terrestrial frequencies that are used by the ASN are denoted F′_{T}. In some embodiments, a terrestrial cellular frequency F′_{T} also may be used for communications between the ASC 210 and the gateway 220. In other embodiments, the ASC 210 and the gateway 220 may communicate using other (non-terrestrial cellular) frequencies. In yet other embodiments, communications between the terrestrial base stations 120 and the ASC 210 may take place using at least one terrestrial cellular frequency F′_{T}, as was described, for example, in connection with FIG. 2. As shown in FIG. 3, the satellite footprint 230 from the ASC 210 may at least partially overlap the terrestrial cellular network 100 footprint. In some embodiments, these footprints may be congruent and, in other embodiments, the entire terrestrial cellular network 100 may be contained within the satellite footprint 230.

As also shown in FIG. 3, within an area of overlap between the terrestrial cellular network 100 and the satellite footprint 230, a radioterminal, such as radioterminal 130a, may communicate with the ASN 200 using at least one terrestrial cellular frequency F′_{T}, to thereby allow some of the capacity of the terrestrial cellular network to be offloaded to the ASN 200. In other embodiments, a radioterminal, such as the radioterminal 130b in the area of overlap, may continue to communicate terrestrially with a base station 120 that is associated with the terrestrial cellular network 100. Moreover, outside the area of overlap, a radioterminal 120c may communicate with the ASN 200 using at least one terrestrial frequency F′_{T}.

It will also be understood that, in other embodiments, multiple cellular networks 100 may be integrated with an ASN 200 and the ASN 200 may be configured to serve the radioterminals of the multiple cellular networks 100 by using at least one frequency, respectively, from each one of the respective cellular networks 100 that are integrated therewith. Finally, it will also be understood that various embodiments of the FIGS. 1-3 may be combined in various combinations and subcombinations according to other embodiments of the invention.

In the drawings and specification, there have been disclosed embodiments of the invention and, although specific terms are employed, they are used in a generic and descriptive sense only and not for purposes of limitation, the scope of the invention being set forth in the following claims.

1. A wireless communication method comprising:
directly communicating between a space-based component and a radioterminal over a terrestrial cellular/PCS frequency.

2. A method according to claim 1 further comprising:
directly communicating between a terrestrial base station and the radioterminal over a terrestrial cellular/PCS frequency.

3. A method according to claim 1 further comprising:
directly communicating between a terrestrial base station and the space-based component over a terrestrial cellular/PCS frequency.

4. A method according to claim 2 further comprising:
directly communicating between the terrestrial base station and the space-based component over a terrestrial cellular/PCS frequency.

5. A wireless communication method comprising:
using a terrestrial cellular/PCS frequency by a space-based component.

6. A wireless communication method comprising:
using a terrestrial cellular/PCS frequency by a radioterminal to directly communicate with a space-based component.

7. A wireless communication method comprising:
using a terrestrial cellular/PCS frequency by a terrestrial base station to directly communicate with a space-based component.

8. A wireless communication system comprising:
a space-based component that is configured to directly communicate with a radioterminal over a terrestrial cellular/PCS frequency.

9. A wireless communication system according to claim 8 further comprising:
a terrestrial base station that is configured to directly communicate with the radioterminal over a terrestrial cellular/PCS frequency.

10. A wireless communication system according to claim 9 wherein the terrestrial base station is further configured to directly communicate with the space-based component over a terrestrial cellular/PCS frequency.

11. A wireless communication system according to claim 8 further comprising:
a terrestrial base station that is configured to directly communicate with the space-based component over a terrestrial cellular/PCS frequency.

12. A wireless communication system according to claim 8 in combination with the radioterminal that is configured to directly communicate with the space-based component over a terrestrial cellular/PCS frequency.

13. A wireless communication system according to claim 9 in combination with the radioterminal that is configured to directly communicate with the space-based component and the terrestrial base station over a terrestrial cellular/PCS frequency.

14. A wireless communication system comprising:
a space-based component that is configured to use a terrestrial cellular/PCS frequency.

15. A wireless communication system comprising:
a radioterminal that is configured to directly communicate with a space-based component over a terrestrial cellular/PCS frequency.

16. A wireless communication system according to claim 15 wherein the radioterminal is further configured to directly communicate with a terrestrial base station over a terrestrial cellular/PCS frequency.

17. A wireless communication system comprising:
a terrestrial base station that is configured to directly communicate with a space-based component over a terrestrial cellular/PCS frequency.

18. A wireless communication system according to claim 17 wherein the terrestrial base station is further configured to communicate directly with a radioterminal over a terrestrial cellular/PCS frequency.

19. A wireless communications system comprising:
a terrestrial cellular network that is configured to communicate with a plurality of radioterminals over a cellular frequency band; and
an ancillary space network that is configured to communicate with at least some of the radioterminals over at least some of the terrestrial cellular frequency band.

20. A wireless communications method comprising:
communicating between a terrestrial cellular network and a plurality of radioterminals over a cellular frequency band; and
communicating between an ancillary space network and at least some of the radioterminals over at least some of the terrestrial cellular frequency band.
